(19) United States
(12) Patent Application Publication
(10) Pub. No.: US 2007/0097204 A1
(43) Pub. Date: May 3, 2007

(54) Portable audio visual communication system and method

(75) Inventors: Rich Gasper, Phoenix, AZ (US); Gianfranco Fiorio, Arlington, VA (US)

Correspondence Address: BRAD CLOSE;TIGHE PATTON, PLLC, 1747 PENN. AVE. NW, SUITE 300, WASHINGTON, DC, 20006-4604, US

(73) Assignee: Alpha Omega International

(21) Appl. No.: 11/590,573

(22) Filed: Oct. 31, 2006

Related U.S. Application Data
(60) Provisional application No. 60/731,700, filed on Oct. 31, 2005.

(51) Int. Cl. H04N 7/14

(52) U.S. Cl. 348/14.01

(57) ABSTRACT

The present invention provides for an audio visual communication system that comprises a communications network, a first central processing unit housed within a body, a display and an audio and visual capturing apparatus. A link between a first central processing unit and a second central processing unit is established over the communications network and audio and visual data is transferred. The data is compressed before being sent and decompressed after being received. Both the data being sent by the central processing unit and data being received by the central processing unit is displayed to the user.

### BACKGROUND

This application claims priority to U.S. Provisional Application No. 60/731,700, filed Oct. 31, 2005.

Although great leaps have been made in telecommunications, a usable audio and visual communication method and system has yet to be achieved that integrates several forms of communication in a portable form. What is needed is a system and method that makes audio-visual communications both usable and portable. Other difficulties with the prior art also exist, some of which will be apparent upon further reading.

### SUMMARY OF THE INVENTION

One embodiment of the present invention provides for an audio visual communication system that comprises a communication network, a central processing unit, a display operably connected to the central processing unit and audio and visual capturing apparatuses.

In another embodiment, the present invention provides for an audio-visual communication system comprising a body, a central processing unit in operable communication with the display, at least one camera operably connected to the display, at least one microphone operably connected to the central processing unit, a power source, at least one data port, and a communications network operably connected to the central processing unit. The central processing unit is adapted to allow at least one first user to simultaneously transmit at least a first set of audio and visual data to at least a second user through the communication network while the at least one second user transmits at least a second set of audio and visual data to at least one first user. The display is adapted to change its orientation and its mode upon the occurrence of a change in the orientation of the body of the system. The display is also adapted to display sets of audio and visual data simultaneously. The central processing unit is adapted to optimize the bandwidth and data rate.

In yet another embodiment of the invention, an audio-visual communication system is provided that comprises a body, a display about the body, a central processing unit in operable communication with the display, at least one camera operably connected to the display, at least one microphone operably connected to the central processing unit, a power source, at least one data port and a communications network operably connected to the central processing unit. The central processing unit is adapted to allow at least one user to simultaneously transmit a set of audio and visual data to at least a second user through the communication network while a second user transmits at least a second set of audio and visual data to the first user. The display is adapted to display the sets of audio and visual data simultaneously. The central processing unit is also adapted to optimize the bandwidth and data rate.

### BRIEF DESCRIPTION OF THE FIGURES

FIG. 1 illustrates a two-way display according to one embodiment of the present invention having quick launch buttons for 2-way communications and video communications.

FIG. 2 illustrates the embodiment of FIG. 1 with the display in a vertical orientation.

FIG. 3 is another embodiment of the system of FIG. 1 with a stand along the body of the system for propping.

### DETAILED DESCRIPTION OF THE INVENTION

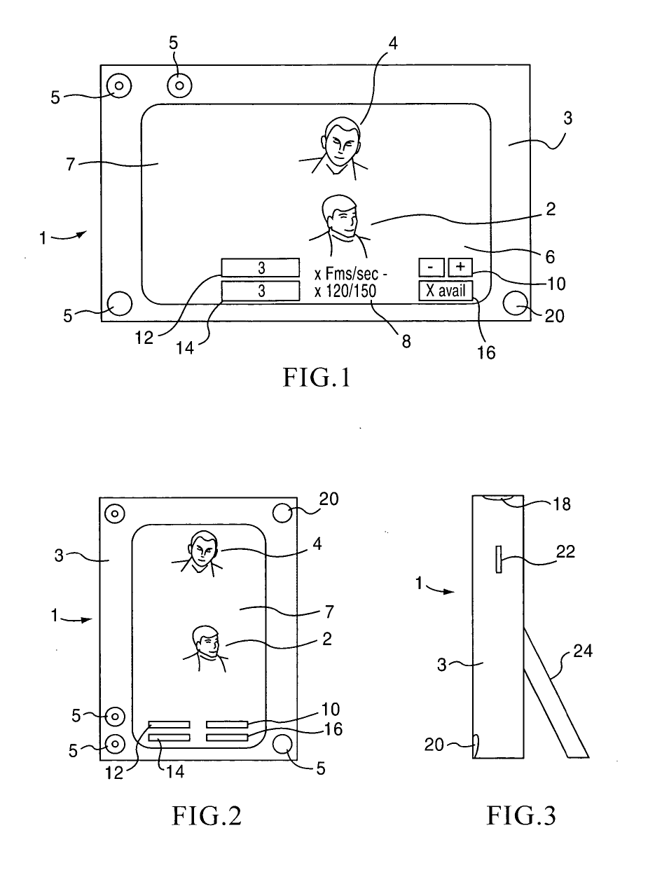

With reference to FIG. 1, the present invention 1 provides for portable audio and visual (AV) communication methods and systems over a communications network for a plurality of users in a plurality of locations. The system 1 allows real time communication between parties. Each user 2, 4 sends to the other users 2, 4 an AV data stream. Each user has a display 6 that shows the visual portion of each of the other user's AV data streams, as well as the visual portion of their own data stream that they are sending to other users. Therefore, each user has a display 6 showing all of the users 2, 4, including themselves.

The system of the invention 1 comprises a central processing unit (CPU) housed within a body 3. The central processing unit is adapted to run cross-platforms. The CPU may run either Apple® or Windows®-based software programs and may be adapted to act as a computer, telephone, television, video game, personal digital assistant (PDA), or any other computerized device. The CPU may be adapted to allow movies, games, television shows and music to be downloaded, played and displayed. The system will comprise at least one port 22 located about the body 3 of the system 1 to facilitate the introduction of saved data into the system, including, but not limited to movies, music, music videos and television shows.

The images are compartmentalized on a single display 6 (though in some embodiments multiple displays 6 are used). In a specific embodiment of the invention, the display 6 is about 9″×7″. In another embodiment of the invention, the display 6 is about 4″×6″. The small display 6 allows a user to communicate with others and to access information without being held to a single location.

With reference to FIGS. 1 and 2, the display 6 may be changed such that it is viewed by any user with the system oriented horizontally or vertically. FIG. 1 illustrates a horizontal orientation. FIG. 2 illustrates a vertical orientation. A user 2, 4 simply tells the system 1 which direction to set the display 6 by pressing a button or making a choice on the LCD panel 7. The orientation of the display 6 is not necessarily related to the mode in which the system is being used. As used herein, “mode” refers to the current use of the CPU. For example, the invention may be used in a telephone mode, a PDA mode, a computer mode, a 2-way mode, or a music mode. In certain embodiments, the CPU may be used in multiple modes simultaneously.

In one embodiment the system 1 is adapted to automatically change modes when the orientation of the body 3 of the system 1 changes. For example, the system 1 may go from a telephone mode when in a vertical orientation, to a portable digital assistant or computer mode when it is turned horizontally. In this embodiment, the orientation change occurs automatically upon the change in direction of the body 3 of the system 1. In alternative embodiments, however, the orientation of the display 6 is activated by the user's act of communicating a choice to change the orientation of the display by pressing a button 5, or making a choice on the LCD panel 7.

In a similar embodiment of the invention, the system is adapted to automatically change the orientation of the display when the orientation of the body of the system changes. For example, when a user changes the orientation of the system from horizontal to vertical, the displayed image goes from horizontal to vertical. In this embodiment, the change occurs automatically upon the change in the direction of the body 3 of the system 1.

In alternative embodiments, however, the orientation of the display is activated by the user's act of communicating a choice to do so by pressing a button 5, or making a choice on the display 7.

It should be noted that in specific embodiments of the invention both the orientation of the display and the mode in which the system 1 is operating automatically changes when the orientation of the body 3 is changed from horizontal to vertical, or vertical to horizontal. It should also be noted that as used herein, the terms “horizontal” and “vertical” are with reference to the ground and are estimates. In other words, “horizontal” means that the body of the system has its longer side about parallel to or about 180 degrees to the ground. “Vertical” means that the body of the system has its longer side at about a 90 degree angle to the ground. These measurements are not meant to be specific and may vary by about 45 degrees in any direction.

In a more specific embodiment, illustrated in FIGS. 1 and 2 the audio-visual communication system 1 comprises a body 3, a central processing unit in operable communication with a display 6, at least one camera 18 operably connected to the display 6, at least one microphone 20 operably connected to the central processing unit, a power source, at least one data port 22 and a communications network operably connected to the central processing unit. The central processing unit is adapted to allow at least one first user 2 to simultaneously transmit at least a first set of audio and visual data to at least a second user through the communication network while the at least one second user 4 transmits at least a second set of audio and visual data to at least one first user. The display is adapted to change its orientation and its mode upon the occurrence of a change in orientation of the body of the system. The display 6 is also adapted to display at least one first and second set of audio and visual data simultaneously. The central processing unit is adapted to optimize the bandwidth and data rate.

In one embodiment of the invention, a backlit LCD panel is employed as the display. The LCD panel allows a user to make choices, i.e. to press buttons, simply by tapping on the display 6. A user may also press buttons 5 or make choices using a standard PS/2 mouse, as in one embodiment of the invention, or using a keyboard, which may be built into the system, or may be detachable, as in certain specific embodiments of the invention, or connected remotely using infrared connectivity. A stylus may also be employed. In accordance with the invention, any known means for communicating a choice may be employed.

A link between the first central processing unit and the second central processing unit is established over the communications network. Audio and visual data is transferred between the central processing units, and compressed before being sent and decompressed after being transferred over the communication network. Both the data being sent by the central processing units and data being received by the central processing units are displayed. The users may set at least a frame rate of the visual data being sent over the communications network.

In a particular embodiment, a suggested optimization is given to the user for the frame rate of the visual data and an overall data rate. Also, at least one additional user control, shown as buttons 5 in FIGS. 1 and 2, sets at least the frame rate of the visual data and an overall data rate of the audio and visual data that is being sent over the communications network.

In other embodiments, the first user 2 sets at least the frame rate of the visual data and an overall data rate of the audio and visual data that is being sent over the communications network. Also, the setting may be a request that the additional user(s) 4 may accept or reject.

In another embodiment, the audio visual communication method uses cryptical compression.

In some embodiments, at least one additional user is a person. In still other embodiments, the central processing unit is within at least one of a computer, a PDA, a cell phone or a game console. And in still other embodiments, the display 7 displays at least one of, the at least one additional user's data rates, the at least one additional user's maximum data rates, a time of the communications, local times, cost of communication, maximum bandwidth available on the communications network, and other users available on the communications network.

The system of the invention 1 comprises a power source. Any known internal or external power source may be used. In certain embodiments utilizing batteries as the power source, the system 1 will power down after a predetermined amount of time to save power and extend battery life.

Each user 2, 4 can adjust the AV data stream that they are sending to the other user(s). The adjustments include frame rate controls and data rate controls. The frame rate controls the number of frames in a given period of time (frames/sec), while the data rate controls the total volume of data (e.g. kilobytes) that a user is sending out, and as a result, how much bandwidth they are sending out. In some cases, optimal adjustments will be suggested by the system 1. In particular embodiments, the user 2 may set certain guidelines which are then optimized. For example, a user may request a minimum of 3 frames/sec. and a maximum of 300 kb of data rate, and the AV data stream is optimized within these parameters; or a minimum of 10 frames/sec and a maximum of available bandwidth. These settings are accomplished using the buttons 5 located on the body 3 of the system 1, or by any other means of communicating the choice to the CPU.

Once a frame rate and data rate are set, the local AV software adjusts the quality of the image based on the remaining bandwidth available. The user 2 sees the frame rate and quality of their image near instantaneously and can quickly make adjustments. Quality enhancing techniques that improve the quality of the image and sound may be used. For example, the software may recognize images that are stationary in the picture and therefore no image updating will be required for those sections. The data consumption that would have been used in that section of the display 6 can then be used for other portions of the display 6. Other quality enhancing techniques will be apparent to one of ordinary skill in the art.

In many cases, the available bandwidth can vary often. Therefore, particular embodiments of the invention give constant readouts of available bandwidth. Although in many embodiments the user is given the opportunity of constant control over the adjustments, the amount of available bandwidth can affect the adjustments that a user has selected. As a result, the user may be warned when bandwidth is no longer compatible with the selected adjustments, or the adjustments may be over-ridden. For example, a user that selected 10 frames/sec, at a drop in bandwidth has the frame rates drop to 8 and further adjustments will only allow for adjustments in the frame rate of up to 8 (although, at that time, as user may wish to select even lower frame rates to improve the image quality). The selected adjustments may be displayed on a user's display, both what is selected and what is actually obtained if the two are not the same, particularly when the bandwidth is quickly changing. This information may also be sent to the displays of the other users.

In some embodiments a user may control the data stream that they are receiving from the other user(s) in a similar manner. A user 2, 4 may adjust the AV data stream separately for each of the other users that are on the system, or they may have a global adjustment, which performs the same adjustments for each. The global adjustments may also have an averaging function, for example, instead of saying use 100 kb for each of the other users, a user instead may say use 500 kb total and divide it among the other users. Also, a user may select an option where the system 1 selects the frame and data rate for them based upon available bandwidth and predetermined factors, like processor speed, and traffic load over the communications network.

When a user adjusts the AV data stream of another user, a control message (request) is sent over a communications network to that other user's system. That other user's system is in the meantime collecting local AV data for a future AV data stream that has maximum total bandwidth usage. This AV data is adjusted based on what requests are being sent from the other user's computer, if the requests are granted. In some cases, the request may be adjusted based on determined local parameters, or even denied. This embodiment is particularly useful when the other user is handicapped or is not a particular individual, such as a group, area, or animal.

Once the frame rate is established, the other user's system then adjusts the picture quality, and in some cases, sound quality, based on the remaining available data rate.

The methods and systems of the invention comprise at least one built-in communications network, such as a 10/100 Ethernet connection, and is able to run standard Windows® applications, including but not limited to Win 32® applications. In specific embodiments of the invention, the connectivity of the system can be expanded using Bluetooth® and/or WiFi® technology. At least one communication port is employed to facilitate the expansion.

In all cases, the AV data is compressed and sent out over the communications network to the other user(s). Solid state mass storage is employed using compression technology. A user's system receives and decompresses the AV data stream, displaying and playing the AV as described. The other user's system is simultaneously performing the same functions.

Although security measures known in the art may be used, an additional security measure of the present invention is to use cryptical compression. The cryptical compression refers to a secret or unobvious way of compression, such that one of ordinary skill in the art would not be able to de-compress the compressed data without the provided de-compression software. For example, in order to decipher a compression, someone would have to know the compression structure being used down to the level of developed header values that represent compression schemes, and how other compression choices are made. Compression technology is known in the art, but some providers include Alpha Omega™ Inc, Microsoft™, and Real™.

In some embodiments, the AV data stream will also contain data information, such as frame rate, frame rate maximums, data rate and data maximums. In some embodiments, the user's system further indicates a maximum data rate allowable. The maximum data rate allowable may also be sent to the other users. The user's system may also indicate an optimal frame rate. Within the system there is an outgoing and incoming frame buffer. The compression takes place between the outgoing frame buffer and the transmission control protocol (TCP) and decompression takes place between TCP and the incoming frame buffer.

The system of the invention comprises, in certain embodiments, record/play software, which includes compression/decompression software, a visual display and audio speaker/microphone, a computerized protocol enabled network connection, such as phone, “Internet” and Intranets, cable, or cell/satellite phone. Examples of systems that may use the present invention include cell phones, personal digital assistants, computers, game consoles, and similar systems. The AV system software can be launched in a manner similar to a game so that the game console becomes a conferencing console.

The adjustment interface may be varied, but one embodiment (shown in FIG. 1) comprises graphic linear bars with an adjustable tab. In addition, these adjustments may be displayed simultaneously with the rest of the images, or they may be on a separate page that may contain only the image that they are connected to. The audio and video may be separated into different streams and sent separately. As a result, they may be manipulated and sent separately. In some cases, the picture and audio may be discontinued in favor of the other.

In order to help system-to-system compatibility, the programs controlling the AV communication method can be written in universal code. Examples of universal code include Assembler®.

In some embodiments, exclusive 2-way communication is used. That is, a single user-to-user link is established and two images are put on display. This 2-way communication may be established automatically with the sending of an initial message. For example, a first user calls a second user on a cell phone that has a display. As soon as the second user answers, the 2-way communication of the present invention is initiated. The technology is also activated by simply pressing a button 5 in certain embodiments. The buttons 5 automatically activate this technology when pressed.

In accordance with the invention, two users can communicate with each other and see each other simultaneously. The user can see both himself and the person in communication with that user. The invention achieves this goal by employing an integrated color 180 degree swivel camera 18 in one embodiment. The camera may be located anywhere on the system, including on the side edge of the system. The system of the invention also comprises a microphone 20 which is integrated into its body 3.

FIG. 1 illustrates an example of the present invention. In this example a first user 2 sees himself on the bottom portion of a display 6 and a second user 4 is shown on a top portion. The orientation of this may be changed, and in some applications, such as with desktop and laptop computers, only a fraction of the display 6 may be dedicated to the AV communication method. The first user sees the second user, and in this embodiment is given a “readout” of the frame rates per second, as well as the overall data rate, which includes the maximum available. In this example the data rate is given as a “120 of 500” format, but could equally be displayed as a percentage or other mechanism. Also in this embodiment, the first user 2 is given a choice of selecting a higher quality image, which may be accepted or ignored by the second user.

The first user 2 is also shown a display of the frame rate 12 and data rate 14 that he is sending, as well as the maximum available bandwidth 16, which may fluctuate constantly. The rates for the first user are displayed on a sliding bar, since the first user is allowed to adjust them constantly. In some embodiments this may be hidden, or brought up in a separate window. Also available is an optimize function 18 which will optimize the frame rate and image quality based on the available bandwidth. This optimize function may be the system default, and the user has to actively de-select to switch to manual.

In addition to the embodiments shown in FIGS. 1 and 2, the system of the invention is adapted to run other applications simultaneously. For example, the central processing unit can use Pentium IV® technology and run Windows® applications. The system of the invention generally uses Unicode, and therefore can also run Apple® applications. Current systems known in the art use too much bandwidth, which prevents cross-platform use and results in low frame rates, which in turn results in poor display quality. These applications are running on the display 6 at the same time in specific embodiments. For example, two users playing a cooperative video game may have the video game running on display 6 as well, or two users simultaneously going over the same spreadsheet, article, map, etc.

In one embodiment the present invention provides for an audio visual communication method that comprises a first user 2 and at least one additional user 4. A communications network, a first central processing unit for the first user and a second central processing unit for the second user. The central processing units are operably connected to a display 7, an input control have, access to the communications network and an audio and visual capturing apparatus. A link between the first central processing unit and the second central processing unit is established over the communications network and audio and visual data is transferred between the central processing units. The data is compressed before being sent and decompressed after being received. Both the data being sent by the central processing units and data being received by the central processing units are displayed on the central processing units. The first user sets at least a frame rate of the visual data and an overall data rate of the audio and visual data that the first central processing unit is sending over the communications network.

In a particular embodiment, a suggested optimization is given to the user for the frame rate of the visual data and an overall data rate. Also the at least one additional user controls sets at least the frame rate of the visual data and an overall data rate of the audio and visual data that the second central processing unit is sending over the communications network.

In other embodiments, the first user sets at least the frame rate of the visual data and an overall data rate of the audio and visual data that the second central processing unit is sending over the communications network. Also the setting may be a request that the at least one additional user may accept or reject.

In another embodiment, the audio visual communication method uses cryptical compression.

In some embodiments the at least one additional user is a person. In still other embodiments, the central processing unit is at least one of a computer, a PDA, a cell phone or a game console. And in still other embodiments the display contains at least one of, the at least one additional user's data rates, the at least one additional user's maximum data rates, a time of the communications, local times, cost of communication, maximum bandwidth available on the communications network, and other users available on the communications network.

In a specific embodiment of the invention, the system of the invention comprises a built-in microphone. In a more specific embodiment of the invention, the system further comprises at least one other additional line inputs, preferably two line inputs.

With reference to FIG. 3, to facilitate use of the system 1 at the desktop, a means for propping 24 the system 1 so that the display 6 is visible to the user 2 is employed. Any means 24 capable of accomplishing such may be used.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which, is to be given the full breadth of the claims appended and any and all equivalents thereof.

What is claimed is:

1. An audio-visual communication system comprising:
a body;
a display about said body;
a central processing unit in operable communication with said display;
at least one camera operably connected to said display;
at least one microphone operably connected to said central processing unit;
a power source;
at least one data port;
a communications network operably connected to said central processing unit;
wherein said central processing unit is adapted to allow at least one first user to simultaneously transmit at least a first set of audio and visual data to at least a second user through said communication network while the at least one second user transmits at least a second set of audio and visual data to the at least one first user;
wherein said display is adapted to display the at least one first and second sets of audio and visual data simultaneously; and
wherein said central processing unit is adapted to optimize the bandwidth and data rate.

2. The system of claim 1 further comprising a means for propping the body.

3. The system of claim 1 further comprising a detachable keyboard.

4. The system of claim 1 wherein said display is about 6 inches by 8 inches.

5. An audio-visual communication system comprising:
a body;
a display about said body;
said display adapted to change its orientation upon the occurrence of a change in orientation of said body of said system;
a central processing unit in operable communication with said display;
at least one camera operably connected to said display;
at least one microphone operably connected to said central processing unit;
a power source;
at least one data port;
a communications network operably connected to said central processing unit;
wherein said central processing unit is adapted to allow at least one first user to simultaneously transmit at least a first set of audio and visual data to at least a second user through said communication network while the at least one second user transmits at least a second set of audio and visual data to the at least one first user;
wherein said display is adapted to display said at least one first and second sets of audio and visual data simultaneously;
wherein said display is adapted to change the orientation of the display and the mode in which said system is operating upon the occurrence of a change in the orientation of the body independently; and
wherein said central processing unit is adapted to optimize the bandwidth and data rate.

6. The system of claim 5 wherein said change in orientation occurs automatically upon the occurrence of a change in orientation of the body.

7. The system of claim 5 wherein said change in orientation occurs when a user communicates a desire for change to the system.
